(19) United States
(12) Patent Application Publication
(10) Pub. No.: US 2007/0239970 A1
(43) Pub. Date: Oct. 11, 2007

(54) Apparatus For Cooperative Sharing Of Operand Access Port Of A Banked Register File

(76) Inventors: I-Tao Liao, Taipei (TW); Chuan-Cheng Peng, Yung-Ho City (TW); Po-Han Huang, Taipei (TW); Chuan-Hua Chang, Taipei (TW)

Correspondence Address: LIN & ASSOCIATES INTELLECTUAL PROPERTY, P.O. BOX 2339, SARATOGA, CA, 95070-0339, US

(21) Appl. No.: 11/278,824

(22) Filed: Apr. 6, 2006

(51) Int. Cl. G06F 9/44

(52) U.S. Cl. 712/225

(57) ABSTRACT

An apparatus for cooperative sharing of operand access port of a banked register file comprises a partitioned register file, a first group of functional unit, a second group of function units and an access control circuit. The access control circuit includes three control bits to control the accesses to the register file by the functional units for operands. The invention is to relax the constraint encountered by the compiler and a smart assembler using a conventional Ping-Pong file register. The relaxed constraint allows the two banks of the partitioned register file accessed by two instructions simultaneously as long as each corresponding operand of the two instructions are in different register banks. By the relaxed constraint, a compiler and a smart assembler have more choices to schedule instructions in a program, potentially increasing program performance.

### FIELD OF THE INVENTION

The present invention generally relates to computer organization, and more specifically to an apparatus for cooperative sharing of operand access port of a banked register file.

### BACKGROUND OF THE INVENTION

A typical multiported register file includes multiple registers each having a plurality of read ports and at least one write port. What coupling to the register file are instruction decoders which decode instructions held in a plurality of instruction packets. Typically there are two read ports for each instruction register to allow both source operands to be fetched simultaneously. Each register included in a register file is associated with a corresponding functional unit. A very long instruction word (VLIW) processor or a superscalar architecture typically has this kind of organization.

The register files included in a conventional VLIW processor are usually used to increase the execution efficiency. In a conventional VLIW processor, a register file supporting the simultaneous execution of two instructions has four read ports and two write ports as most instructions have two read operands and one write operands. However, conventional register files with multiple ports can consume significant power and die area. Therefore, while this design is popular for many products, the increasing emphasis on lower power consumption of portable devices requires innovative ways to further reduce the power consumption of accessing the register file.

One way of reducing the power consumption to a register file is to reduce the read and write ports of a register file. The conventional method is to partition the register file into two register banks, an even bank and an odd bank. The registers in each bank can be built with two read ports and one write ports. At any point in time, such a register bank can support only one instruction instead of two instructions. But together, the two register banks can still support two instructions simultaneously as long as the two instructions access different register banks. To achieve this requirement of accessing different register file banks by two independent instructions in a static-scheduled processor (i.e. VLIW processor), a compiler or smart assembler is used to enforce this rule by putting two instructions in the same parallel execution instruction packet accessing different banks. This technology is usually referred to as Ping-Pong register file.

FIG. 1 shows a block diagram of a conventional Ping-Pong register file in a computer organization. The Ping-Pong register file is implemented using six 2:1 multiplexers controlled by a ping-pong control bit. As shown in FIG. 1, functional units (FU) 1010, 1011 can access a Ping-Pong register file 102 consisting of register banks 1020, 1021. A Ping-Pong bit 103 is used to control the operation of a plurality of multiplexers to ensure that simultaneous accesses are correctly executed. With this design, the following two instructions I1, I2, for example, executed respectively by functional units 1010, 1011, can access the Ping-Pong register file at the same time in the same instruction packet. In this example, instruction I1 is arranged to use the even register bank 1020 while instruction I2 is arranged to use the odd register bank 1021.
(I1) Add r0,r2−>r4|(I2) Add r1, r3−>r7.

Although this technology can be used to reduce the complexity of the register file, the performance of a program may be degraded most of the time due to the abovementioned constraint. For example, if the data consumed by instruction I2 are all resided in the even register bank, then instruction I1 and I2 cannot execute in parallel in the same cycle and instruction I2 has to be executed in the next cycle. This may sometimes lead to wasted cycles as there may not be sufficient instructions that may be scheduled in the same cycle.

### SUMMARY OF THE INVENTION

The present invention has been made to overcome the above-mentioned drawback of conventional Ping-Pong register file. The primary object of the present invention is to provide an apparatus for cooperative sharing of operand access port of a banked register file. The apparatus comprises a register file partitioned with a first and second register banks, a first functional unit, a second function unit, and an access control circuit. The access control circuit further includes three control bits and a plurality of selection elements to control the accesses to the register banks for the functional units.

An advantage of the present invention is that it allows simultaneous accesses to a banked register file while reducing the power consumption.

Another advantage of the present invention is that it has a performance improvement in instruction scheduling.

Yet another advantage of the present invention is that it has a performance improvement while preserving the circuitry area and power consumption benefits of the partitioned Ping-Pong register file technology.

The main feature of the present invention is to relax the aforementioned constraint encountered by the compiler and a smart assembler using a conventional Ping-Pong file register. Instead of scheduling two instructions in the same parallel execution instruction packet accessing different banks, the relaxed constrain will allow the two banks of the partitioned Ping-Pong register file to be accessed by two instructions simultaneously as long as each corresponding operands (two read and one write) of the two instructions are in different register banks. By the above relaxed constraint, a compiler and a smart assembler have more choices to schedule instructions in a program, potentially increasing program performance.

For example, the following two instructions can now be scheduled in a VLIW parallel execution packet with a Ping-Pong register file of the present invention, while such a parallel scheduling is not possible with a conventional Ping-Pong register file.
(I1) Add r1, r2−>r4|(I2) Add r0, r3−>r7
Note that now operands in instruction I1 or the operands in instruction I2 can be from different banks, as long as the corresponding operands are in different register banks. This greatly increases the flexibility of instruction scheduling for a compiler or an assembler.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

FIG. 1 shows a block diagram of a conventional partitioned Ping-Pong register file in a computer organization.

FIG. 2 shows a block diagram of an embodiment of the apparatus according to the present invention.

FIG. 3 shows a schematic view of a 4×4 16-bit matrix multiplication.

FIG. 4 shows a memory layout of matrix C of FIG. 3.

FIG. 5 shows a memory layout of matrix X of FIG. 3.

FIG. 6 shows a memory layout of matrix Y of FIG. 3.

FIG. 7 shows an assembly code listing using a conventional Ping-Pong register file for the multiplication example in FIG. 3.

FIG. 8 shows an assembly code listing using the present invention for the multiplication example in FIG. 3.

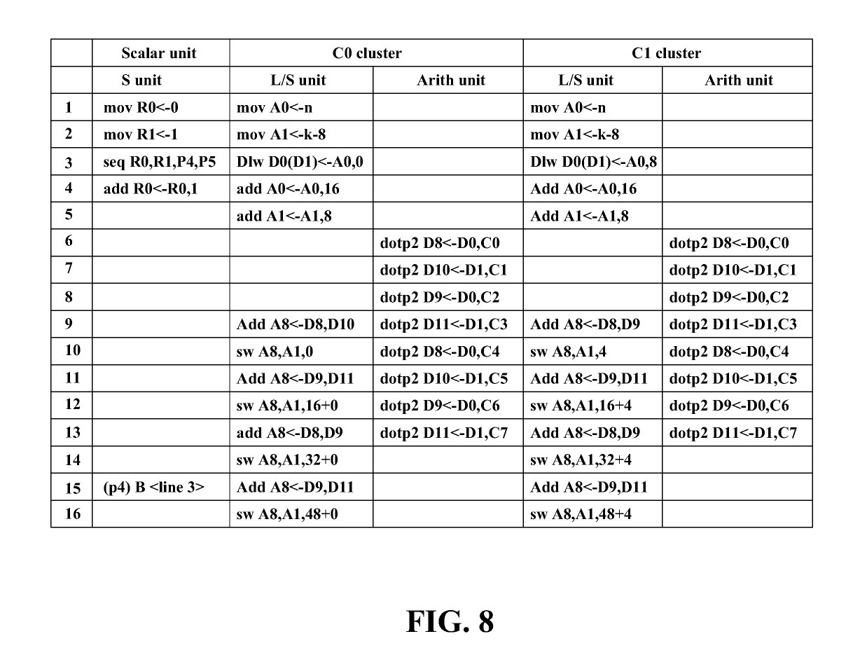

### DETAILED DESCRIPTION OF THE PREFERRED EMBODIMENTS

Throughout the following description, the present invention assume that an instruction has at most two read operands and one write operand, although it can be applied to instructions with more read and write operands.

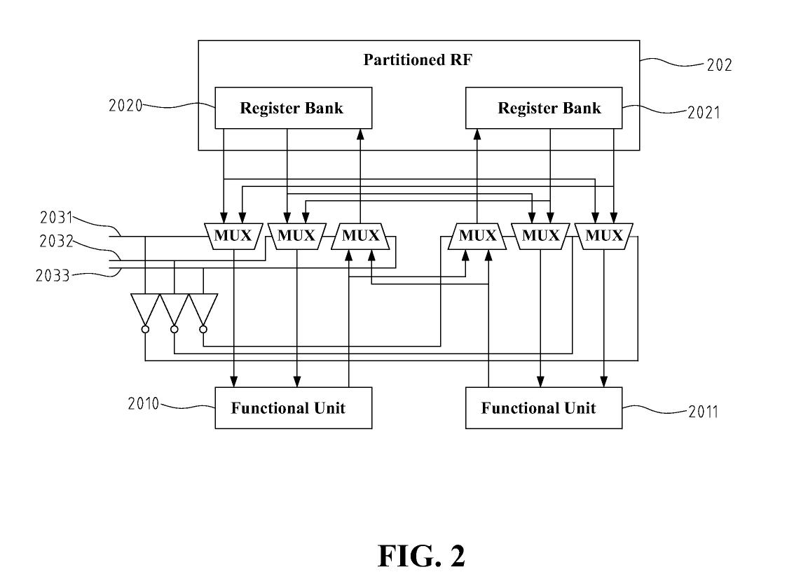

FIG. 2 shows a block diagram of an embodiment of the apparatus for cooperative sharing of operand access port of the present invention. In the embodiment, the apparatus comprises a first functional unit 2010, a second functional unit 2011, a partitioned register file 202, and an access control circuit 203. Without losing generality, the partitioned register file 202 is partitioned into two register banks 2020 and 2021, each register bank having two read ports and one write port. Accordingly, the access control circuit 203 further includes a plurality of selectors such as multiplexers, and three control bits 2031-2033. One control bit controls the cooperative sharing of the write port being associated with the corresponding functional unit. The other two control bits control the cooperative sharing of the two read ports being associated with the corresponding functional unit. Through the access control circuit 203, the two register banks 2020 and 2021 can be accessed by two instructions simultaneously as long as each corresponding operand of the two instructions uses a different register bank. As can be seen in FIG. 2, the first and second functional units 2010-2011 access the partitioned register file 202 through the access control circuit 203.

For easy illustration and description, the access control circuit 203 includes six 2:1 multiplexers and three Ping-Pong control bits 2031-2033. Each 2:1 multiplexer has two inputs and one output and is controlled by the control bits 2031-2033 to determine the data access. Corresponding read ports of register banks 2020-2021 are multiplexed by the multiplexers and used as read operands to functional units 2010, 2011. Similarly, corresponding write operands from the functional units 2010-2011 are multiplexed by multiplexers to the write port of register banks 2020-2021. Control bits 2031-2033 are for controlling the corresponding multiplexers for two read operands and one write operand in each instruction, respectively. With control bits 2031-2033, the corresponding first read operand, the corresponding second read operand and the corresponding write operand of the instruction pair can be individually multiplexed. Therefore, the instruction pair executed in parallel can access the register file simultaneously as long as the corresponding operands are in different register bank.

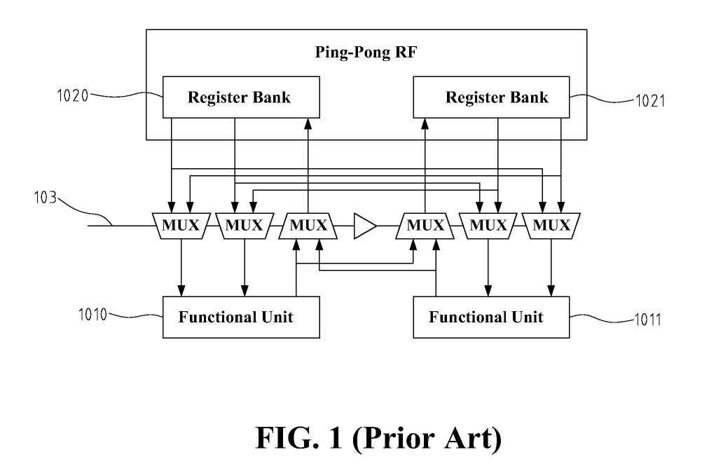

The difference between the present invention and the conventional Ping-Pong register file in a computer organization is in the access control circuit. In FIG. 2, the access control circuit includes three inverters, wherein each inverter has a respective control bit as its input and it outputs the control bit to an associated selector for the cooperative sharing of the operand access port of the banked register file. Comparing FIG. 2 with FIG. 1, the present invention only adds two additional control bits and corresponding inverters and wires. The additional hardware cost of the present invention in comparison with the conventional design is small; hence the increased circuitry and power consumption is also small.

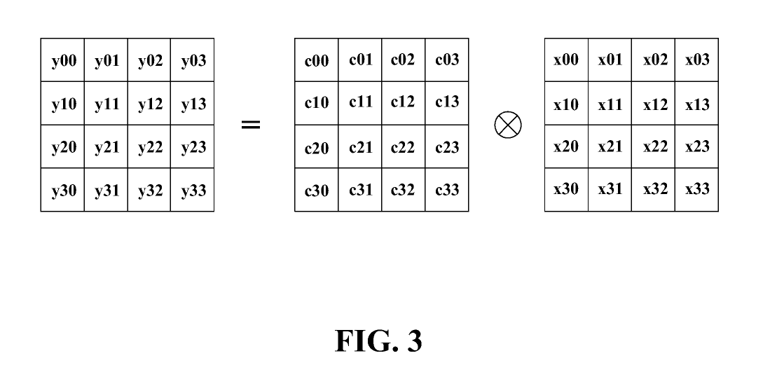

The benefits of the present invention can be illustrated using an example of 4×4 16-bit matrix multiplication Y=CX routine using assembly code implemented on a VLIW processor system with Ping-Pong register file structure. FIG. 3 shows a schematic view of a 4×4 16-bit matrix multiplication Y=CX, where C is a constant coefficient matrix.

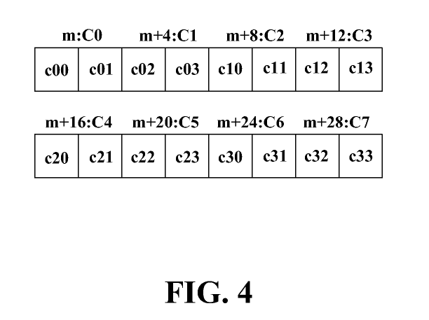

The assembly code is written under the assumption that the sixteen constants are layout in memory in a row-based fashion, as shown in FIG. 4. It is further assumed that all of the sixteen constants have been loaded into registers preparing for continuous 4×4 matrix multiplication operations. Two successive 16-bit coefficients are stored in one 32-bit register.

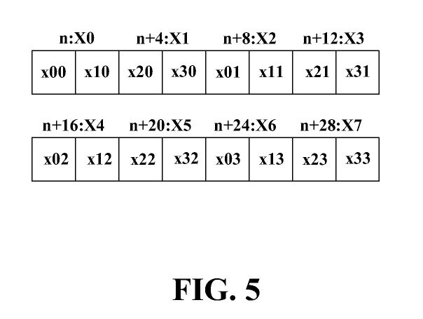

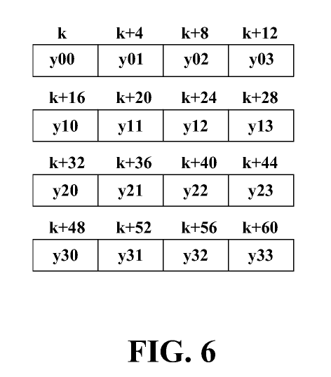

FIGS. 5 and 6 show the memory layout of matrixes X and Y, respectively. Matrix X is assumed to be layout in memory in a column-based fashion, as shown in FIG. 5. All data in matrix X will be loaded into registers in the assembly code. Similar to the constant coefficient, two successive matrix X 16-bit data in memory will be loaded into one 32-bit register for computation. Matrix Y is assumed to be layout in memory in a row-based fashion, as shown in FIG. 6. Each element of matrix Y is 32 bits. The code does not convert the 32-bit element to 16-bit element before storing it back to memory.

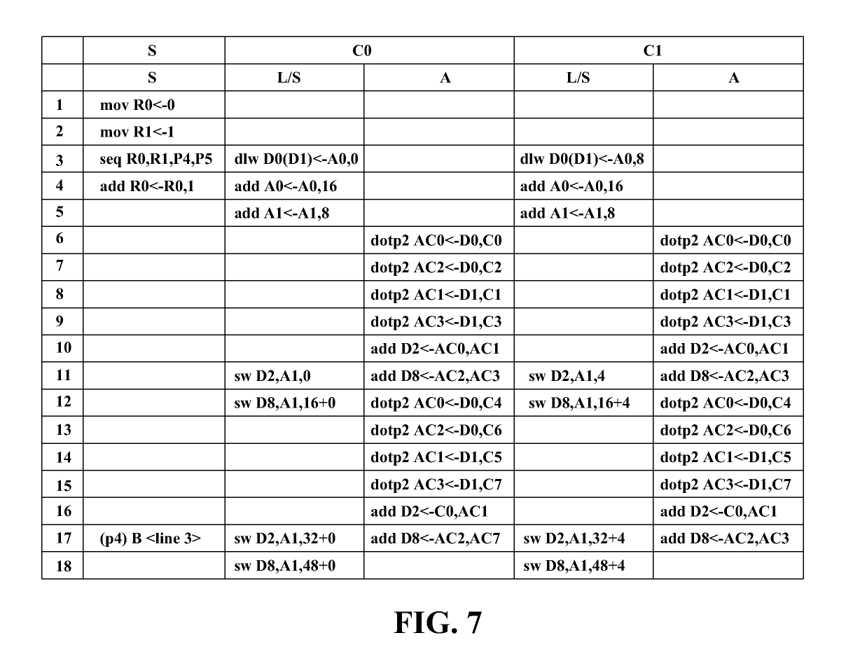

FIGS. 6 and 7 show the assembly code listings for a VLIW processor using a conventional Ping-Pong register file and the present invention, respectively. For both code listings, every cycle, five functional units are available for executing instructions. The computations of the sixteen elements of the matrix Y are equally distributed in two VLIW data path clusters. Cluster 0 is responsible for elements y<0 . . . 3>0 in the first iteration of the code and y<0 . . . 3>2 in the second iteration of the code. Cluster 1 is responsible for elements y<0 . . . 3>1 and y<0 . . . 3>3, also in two iterations, respectively. The order of generating these elements is arranged this way in order to reduce the number of accessing matrix X data from memory. This code uses “dot product” (dotp2 with two cycle latency) instruction to combine three operations (two 16-bit multiply and one 32-bit add) to increase the number of parallel operations every cycle. The dot product instruction multiply the 16-bit low-half pair and the 16-bit high-half pair of the two source operands and then add the results together to form a 32-bit data. Line 1 and line 2 of the code set up the addresses for loading and storing memory and conditions for loop control. Line 3 to line 16 constitutes the main loop body. In line 3, two special “double load word” (dlw with three cycle latency) instructions are used to load a total of 128 bits of data into four registers.

As shown in FIG. 6, the assembly code of using a conventional Ping-Pong register file that supports only the same bank access for the read and write operands of an instruction will take 18 instruction cycles, while the assembly code using the present invention takes 16 instruction cycles to complete the multiplication. There is a 12.5% ( 2/16) performance improvement for a simple example in comparison with the conventional design.

Compared with the conventional techniques, the present invention extends the Ping-Pong register file to accommodate more instruction scheduling flexibility with very minor additional hardware cost and a suitable compiler constraint relaxation. With this extra flexibility, a compiler will be able to generate a more optimized program code to offset the program performance degradation limited by the conventional Ping-Pong register file technology.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. An apparatus for cooperative sharing of operand access port of a banked register file, said apparatus comprising:
a plurality of functional units, each having a plurality of input ports and at least one output port;
a partitioned file register being partitioned into a plurality of register banks, each said register bank having a plurality of read ports and at least one write port; and
an access control circuit, further comprising a plurality of selectors and a plurality of control bits;
wherein said plurality of read ports of each said register bank being selected by said selectors to said input ports of an associate functional unit of said plurality functional units; said output port of said plurality functional units being selected by said selectors to said write ports of said plurality of register banks; and said control bits control said selectors for the cooperative sharing of the operand access port of said banked register file.

2. The apparatus as claimed in claim 1, wherein said apparatus is applies to an instruction with a plurality of read operands and at least one write operands.

3. The apparatus as claimed in claim 1, wherein said instruction has at most two read operands and one write operands.

4. The apparatus as claimed in claim 1, wherein said partitioned file register is a Ping-Pong file register.

5. The apparatus as claimed in claim 1, wherein said selectors are multiplexers.

6. The apparatus as claimed in claim 1, wherein said access control circuit further comprises a plurality of inverters, and each inverter has a respective one of said control bits as its input and it outputs the control bit to an associated selector for the cooperative sharing of the operand access port of said banked register file.

7. The apparatus as claimed in claim 3, wherein said access control circuit includes six 2:1 multiplexers, three control bits and three corresponding inverters and wires.

8. The apparatus as claimed in claim 3, wherein said access control circuit comprises three control bits, and a respective one of said three control bit controls the cooperative sharing of the write port being associated with the corresponding functional unit, and the other two of said three control bits control the cooperative sharing of the read ports being associated with the corresponding functional unit.

9. The apparatus as claimed in claim 8, wherein a respective one of said other two control bits controls said multiplexers multiplexing a respective one read port of each said register bank so that an associate input port of each said functional unit receives the values from different said register banks.

10. The apparatus as claimed in claim 8, wherein said respective one of said three control bits controls said multiplexers multiplexing said output port of each said functional unit so that said write port of each register bank receive the value from different said functional units.

11. The apparatus as claimed in claim 8, wherein said apparatus is applied to a very long instruction word (VLIW) processor.

12. The apparatus as claimed in claim 11, wherein said control bits allow instructions of said a VLIW processor accessing different said register banks executed in parallel.

13. The apparatus as claimed in claim 11, wherein said apparatus allows a VLIW processor to schedule instructions having corresponding read and write operands in different said register banks in the same cycle to improve program performance.
